(19) United States
(12) Patent Application Publication
(10) Pub. No.: US 2007/0289886 A1
(43) Pub. Date: Dec. 20, 2007

(54) Tray and a Case for Storing at Least One Pair of Compact Disks

(75) Inventor: Philippe Cha, Iffendic (FR)

Correspondence Address: FOLEY AND LARDNER LLP;SUITE 500, 3000 K STREET NW, WASHINGTON, DC, 20007, US

(73) Assignee: LA FRANCAISE DES PLASTIQUES, F-35680 Louvigne de Bais (FR)

(21) Appl. No.: 11/577,893

(22) PCT Filed: Oct. 21, 2005
(86) PCT No.: PCT/EP05/55447

§ 371 Date: Jun. 12, 2007

(30) Foreign Application Priority Data
Oct. 26, 2004 (FR) 04 11411

(51) Int. Cl. G11B 23/03; B65D 85/57

(52) U.S. Cl. 206/308.1

(57) ABSTRACT

This plastics material tray of substantially square or rectangular shape is made up both of a central portion provided with a hub suitable for retaining a disk on one of its faces, and of an outer portion referred to as a “frame”—for being adhesively bonded on a support. The tray is remarkable wherein its central portion is essentially detached from the frame, which is secured thereto in part only via a hinged link, and wherein the hub is a double hub, enabling a pair of disks to be retained, one on its outside face and the other on its inside face, thus providing free access to each of the two disks in order to put the disk into place on said central portion or in order to remove it therefrom, by pivoting said central portion to move it away from the general plane containing the frame. The invention applies to packaging compact disks such as CDs and DVDs.

The present invention relates to in particular CDs or DVDS.

The invention also relates to a case (or a box) for storing compact disks, designed to receive one or more trays for storing pairs of compact disks.

More precisely, the invention was devised in the context of improving a case of the type comprising a base sheet of card or similar material, and having fixed thereon a tray of plastics material that is substantially square or rectangular in shape, the tray being made up both of the central portion provided with a hub (or clip) suitable for retaining a disk on an “outside” one of its faces, and of an outer portion—referred to below as a “frame”—adhesively bonded to the base sheet via its opposite, “inside” face.

Nevertheless, the invention may find application in other types of packaging (cases, boxes, etc) in which one or more trays for storing pairs of compact disks are adhesively bonded to a support, the support not necessarily being a sheet of card or similar material.

In a widely sold embodiment, the base sheet consists of a booklet, the tray being fastened on the inside face of its bottom cover, while its top cover is suitable for being folded down onto the tray in order to protect the disk.

In a variant, the booklet has a three flaps; the tray is then fastened on the inside face of the middle portion, and the two covers can be folded down onto the tray on which they are superposed.

The central portion of the tray consists in a setback of circular outline receiving the disk. This setback communicates with four small indentations, likewise in the form of setbacks, that are distributed at the corners of a square at the periphery of the circular setback, in standardized positions.

It is these indentations that are adhesively bonded to the base sheet via their bottom (or inside) faces.

This standardization is useful in enabling different printers to use well-determined handling and bonding tools for sticking the trays onto supports that have already been printed as a function of the content of the disk concerned.

The indentations also have the function of making it easier to take hold of the disk in order to remove it from the hub.

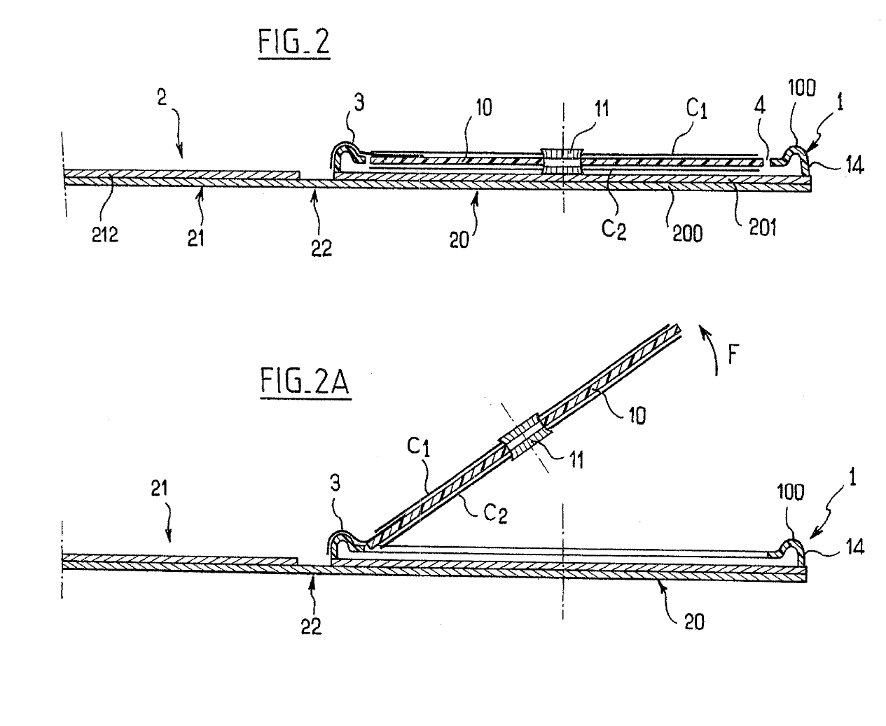

By way of example, packaging of this kind is shown in FIG. 2 of document EP-A-1 239 484.

The hub is generally constituted by a set of resilient fingers that penetrate into the central opening of the disk and retain by friction and/or by clip fastening (see for example documents U.S. Pat. No. 5,494,156 and U.S. Pat. No. 6,364,108).

Such packaging presents the advantage of being practical, lightweight, and relatively inexpensive.

It suffers from the drawback of being capable of receiving only one disk.

The object of the invention is to propose a tray for the same kind of case but capable of receiving a pair of disks.

Nevertheless, a particular configuration of packaging for compact disks is known, in particular from EP-B-0 676 763, that enables at least two disks to be received, each of the two disks being retained by a hub that is offset relative to the other in such a manner that the two disks overlap in part when they are in the superposed position.

Such an arrangement makes the case less compact and makes it necessary to use at least two distinct hubs, which is unfavorable in terms of cost price and ease of use.

It is not compatible with using the adhesive-bonding indentations of the standard configuration.

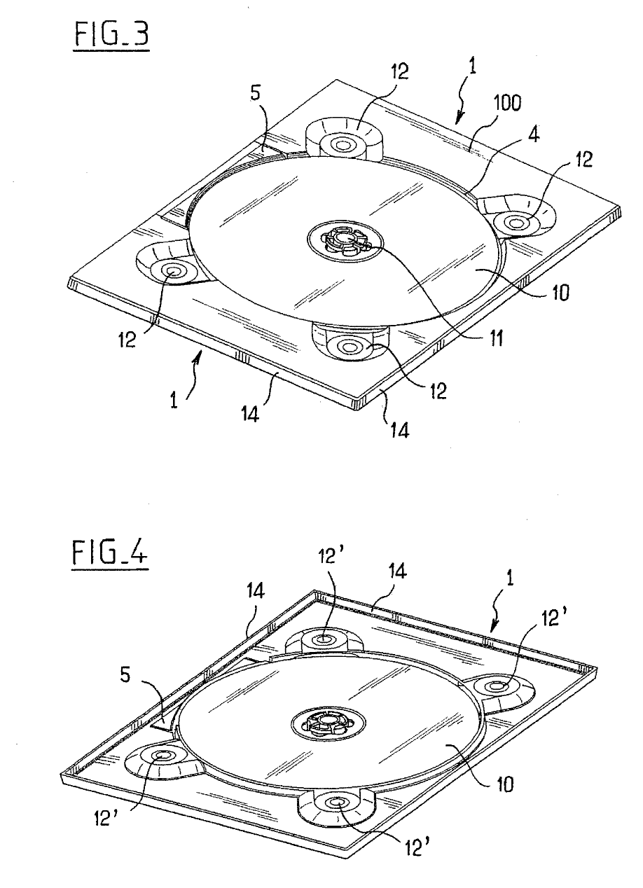

Furthermore, in the variant for receiving two disks only, shown in FIGS. 2 and 3, and to which the present invention applies more particularly, it is very difficult in practice to remove the bottom disk and to put it back into place without previously removing the top disk, unless an excessively large gap is provided for the spacing between their respective planes, and unless the outside thickness of the case is correspondingly excessively great.

An object of the invention is to solve these problems, by proposing a tray of the traditional kind as described above, having standard adhesive-bonding indentations, that is suitable for containing a pair of disks, and without the overall size of the case being at affected.

Another object of the invention is propose a two-disk tray in which is possible to remove one of the disks or to put it back into place, without it being necessary to move the other one.

To this end, and in accordance with the invention, firstly an opening (a through opening) slightly larger than the central portion is provided in the frame, and secondly said central portion is:

essentially detached from said frame, being secured thereto in part only, via a hinged connection;

adapted to be inscribed in said opening; and

provided with a double hub enabling a pair of disks to be retained, one on its outside face and the other on its inside face, thus providing free access to each of the two disks in order to put the disk into place on the central portion or to remove it therefrom, without any need to remove the other disk, access to the disk held against the inside face requiring said central portion to be pivoted away from the general plane containing the frame.

In the storage position, the central portion (together with the disks it carries) thus takes up a position inside the slightly larger through opening formed in the frame. It is not superposed on the bottom wall of the tray, in contrast to what happens with prior art devices.

Furthermore, according to a certain number of characteristics of the invention that are advantageous but nonlimiting:

said central portion is of discoid shape, of diameter corresponding substantially to that of the disks, and said slightly larger opening formed in said frame is a concentric circular opening, said hinged connection comprising a fastener tab secured to said central portion and a hinged to the frame in the central region of one of the sides of the tray;

said central portion is initially rigidly connected to the frame by means of breakable bridges that are suitable for being broken easily on first use;

the central portion and the frame form two distinct parts, and said hinged link between the central portion and the frame is made by means of a label of flexible film adhering to said two parts, e.g. by overmolding;

the central portion and the frame form a single part, and are made of a flexible plastics material that, in their link zone, presents a line of reduced thickness forming a hinge;

the central portion and the frame form two distinct parts, and said hinged link between the central portion and the frame is made by mechanical members such as studs forming stub hinge-pins;

said support is a base sheet of card or similar material and consists of a booklet, the tray being fastened on the inside face of the bottom cover of the booklet, while its top cover can be folded down onto the tray in order to protect the disks;

said hinged link between the central portion and the frame is situated in the vicinity of the edge face of the booklet that interconnects its bottom and top covers; and

the edge of the opening formed in the outside portion is provided at its base with means for retaining and supporting a third disk, such that the third disk is interposed between the disk carried by the inside face of the central portion—when positioned in the general plane containing the frame—and the support onto which the frame is bonded.

In a preferred embodiment of the invention, the tray is made up both of a central portion of circular outline, of diameter that corresponds substantially to the diameter of the disks, being provided in its center with a hub suitable for retaining a disk on an “outside” one of its faces, and of an outside portion—referred to as a “frame”—suitable for being adhesively bonded onto the said support via its opposite, “inside” face, by means of indentation in the form of projections located in the four corners of a notional square within which the circular outline of the central portion is inscribed; the tray is remarkable in that, firstly said central portion is essentially detached from said frame, being secured in part thereto via a hinged link, and secondly it is provided with a double hub enabling a pair of disks to be retained, each on one of its faces, said central portion of generally circular outline being inscribed in a slightly larger concentric circular opening formed in said frame, while the hinged link comprises a fastener tab secured to said central portion, passing between two adjacent indentations, and being hinged to the frame in the central region of one of the sides of the tray.

Under such circumstances, said base sheet may consist of a booklet, comprising a bottom cover onto which said tray is adhesively bonded, and a top cover suitable for being a folded down onto the tray in order to protect the disks, the two covers being connected to each other via pivot lines connecting to an intermediate portion constituting an edge face, of width corresponding substantially to the thickness of said tray, said hinged link between the central portion and the frame being situated in the vicinity of said edge face.

The invention also provides storage case for at least one pair of compact disks, the case including a support on which at least one tray having the above-mentioned characteristics is fastened

Other characteristics and advantages invention appear from the following description given with reference to the accompanying drawings, in which:

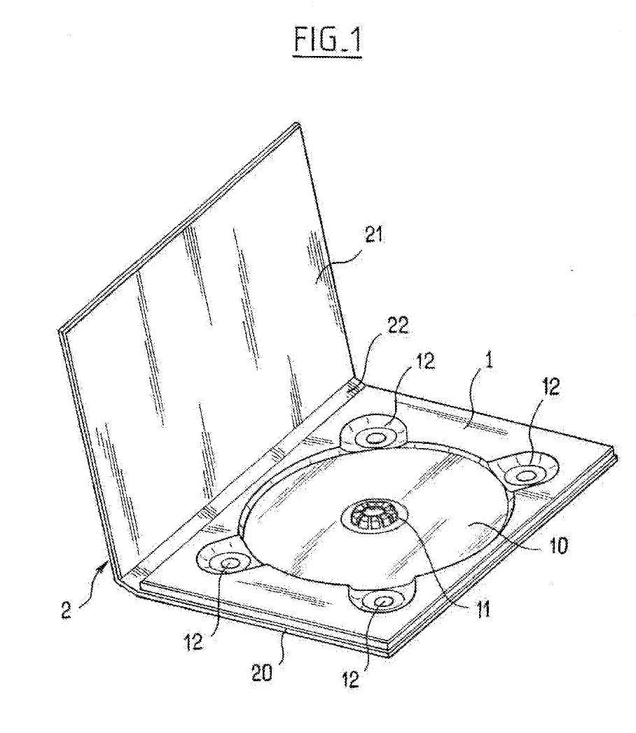

FIG. 1 is a general perspective view of an (open) traditional case in accordance with the state of the art, with the subject matter of the invention constituting an improvement thereof;

FIG. 2 is a diagrammatic fragmentary view of a case provided with a tray of the invention, in section on a transverse plane, with the tray lying flat, in a disk-storage position;

FIG. 2A is a view similar to FIG. 2, with the central portion of the tray being slightly raised;

FIGS. 3 and 4 are perspective view is, respectively from above and below, of a tray in accordance with the invention;

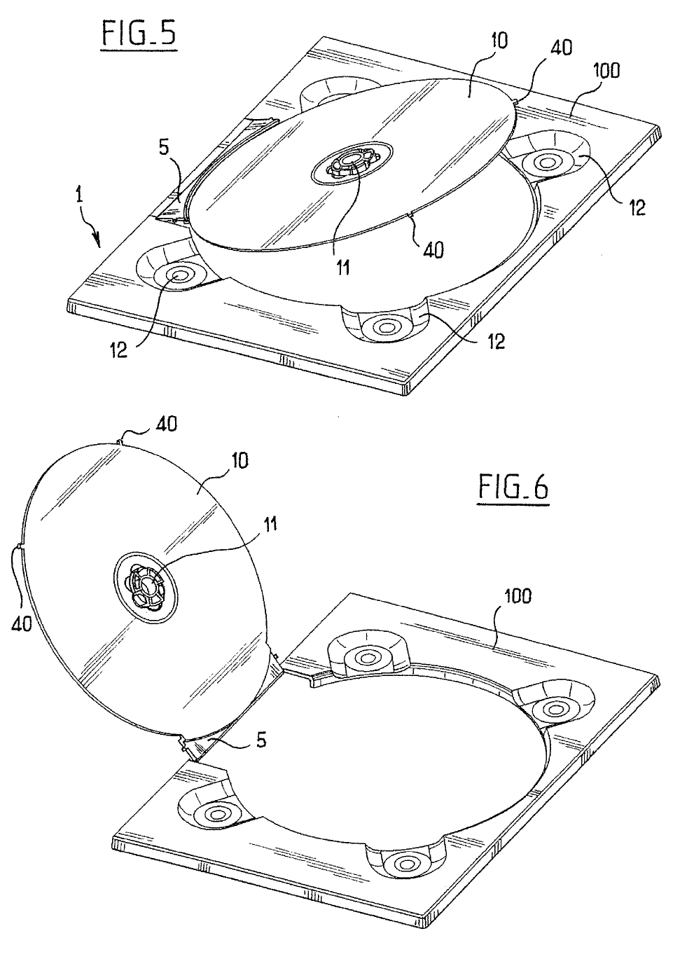

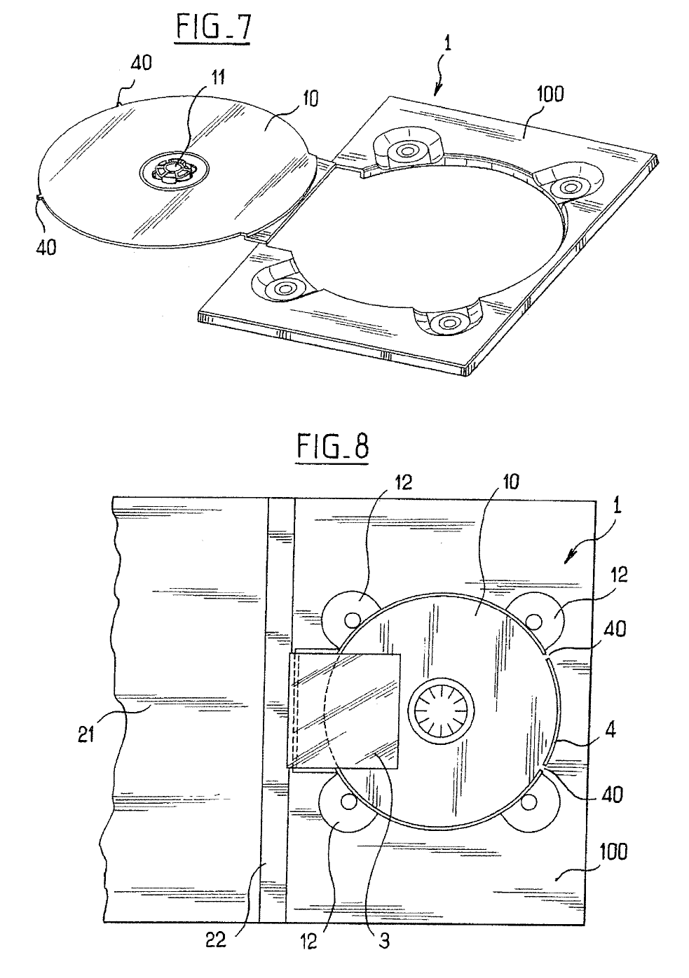

FIGS. 5 to 7 are views similar to that of FIG. 3, showing the central portion of the tray in raised positions, being open at ever-increasing angles;

FIG. 8 is a fragmentary plan view of a case;

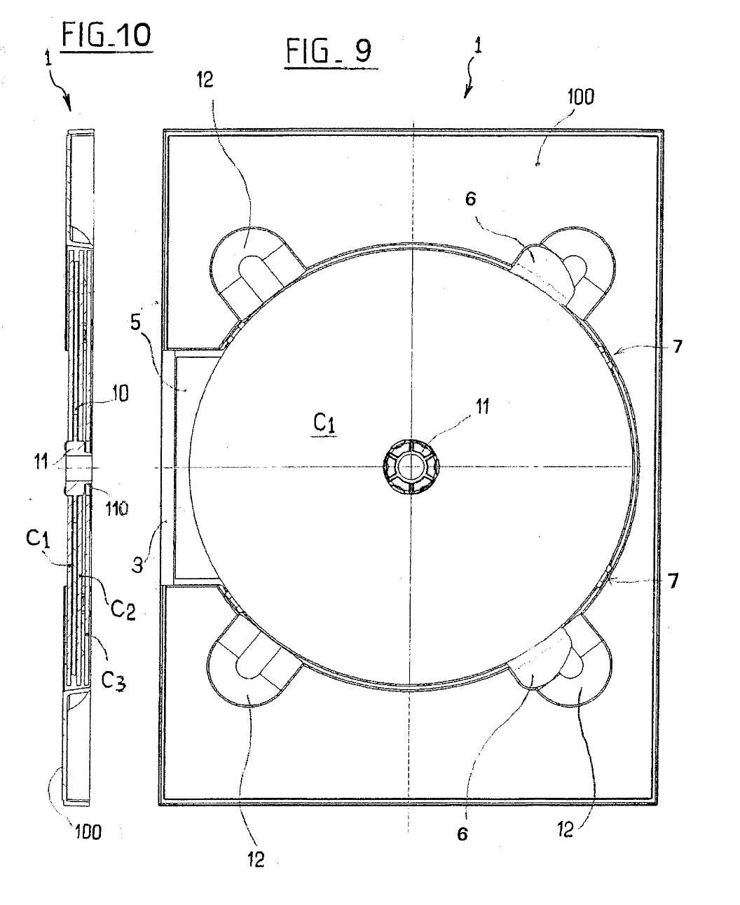

FIGS. 9 to 12 show a variant case, suitable for storing three compact disks;

FIGS. 9 and 10 show the storage tray (without its support), with the disks, respectively seen from above, and in axial section;

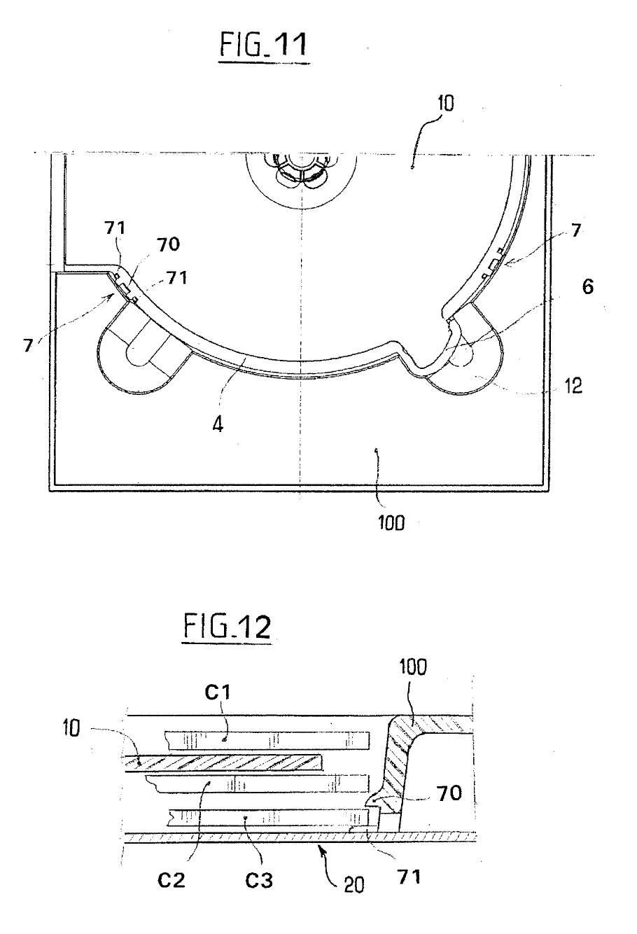

FIG. 11 is a half-view similar to that of FIG. 9, but without a disk; and

FIG. 12 is a detail view showing the means for retaining and supporting a third compact disk.

The tray is shown without its disks, except in FIGS. 2 and 2A, in which the disks (CD or DVD) are designated by references C1 and C2, and except in FIGS. 9, 10, and 12, in which the disks are referenced C1, C2, and C3.

With reference to FIG. 1, which shows a conventional case for storing and protecting a single disk, reference 1 designates a tray of plastics material carried by a card support 2 in the form of a booklet.

The booklet 2 comprises a bottom cover 20, to which the tray 1 is secured, and a top cover 21 suitable for folding down onto the tray 1, together with the disk (not shown) that is stored therein, in order to protect it.

The covers 20 and 21 are square or rectangular in shape, of outline corresponding to the outline of the tray 1. The tray is flat and of small thickness. The covers 20, 21 are interconnected by an edge face 22 of width that corresponds to the thickness of the tray.

As shown in FIG. 2, each of the covers 20 and 21 is advantageously constituted by two card sheets 200 & 201, 200 & 212 that are superposed and adhesively bonded together to form double thickness, while the edge face 22 has only one thickness, corresponding to one of the sheets (200).

The tray one is a hollowed out so as to present a circular central setback 10 that is shallow (i.e. not a through opening); in its center, it is provided with a known type of hub 11, suitable for engaging in the central hole of a compact disk (not shown) in order to retain it securely in the recess.

At the periphery of the recess, there are disposed four indentations 12 that are distributed at 900 intervals in register with the diagonals of the tray. They form projections with their convex sides facing downwards and they are designed to have their bottom (or inside) faces referenced 12′ in FIG. 4 adhesively bonded against the top (or inside) face of the cover 20.

As explained above, these indentations 12 are of standardized shape and position. They present a U-shaped outline, and they open out into the central recess 10 so as to make it easier to take hold of the disk that is received therein.

In accordance with the invention, and as can be seen in particular in FIGS. 3 and 8, the central portion 10 is essentially detached from the remainder 100 of the tray, which surrounds the central portion 10 and is referred to below as the “frame”; it is secured and thereto in part only, via a hinged link.

The central portion 10 is in the form of a discoid, of diameter corresponding substantially to the diameter of the disks, and it is contained in a concentric circular opening of slightly greater size formed in the frame 100.

Between the edge of the opening and the outline of the portion 10, there is thus a small quasi-annular gap 4 interrupted solely via an attachment tab 5. The tab forms an integral part of said central portion 10, and serves to provide the hinged link between the central portion and the frame. The tab 5, of relatively small width, extends between two adjacent indentations 12 situated beside the edge face 22 (see FIG. 8).

It is connected to the edge of the frame 100 situated on this side, in the central region of the frame, and it is hinged thereto.

In the embodiment shown, the hinged link is obtained by means of a flexible film 3, adhering to the two portions 10 and 100, e.g. by overmolding.

A hinge system of this kind is in itself known, e.g. from patent FR 2 783 080, for connecting a disk-carrier tray to a support-strip that is to be inserted in a standard case (see in particular page 5, lines 9-31, and FIG. 2 of that patent).

Nevertheless, it would not go beyond the field of the invention to use a different hinge system, known in itself, in particular by weakening the material forming the hinge (scoring), or by using conventional mechanical pivot pins.

The portion 10 is provided with a double hub 11 enabling a pair of disks C1, C2, to be retained, each on one of its faces, as can be seen in FIGS. 2 and 2A. The double hub 11 is of known type, e.g. of the kind described in above-mentioned FR-B-2 783 080, to which reference can be made where necessary.

The stationary portion of the tray 1, corresponding to the frame, bears against the cover 20, both via its zones of adhesive, corresponding to the indentations 12, and also via its downwardly-curved peripheral edge 14.

As can be seen in FIG. 2, when the device is in its position for storing the two disks C1 and C2, the double hub also comes to bear (via its bottom face) against said cover. It constitutes an abutment that holds the moving central portion 10 properly positioned in the opening of the frame 100, in the thickness thereof, parallel to the cover 20.

It is thus ensured that the disk C2 does not come into contact against the top (or inside) face of the cover 20, and that likewise the disk C1 does not come into contact against the inside face of the cover 21 when the cover is folded down onto the tray 1 in order to protect it (booklet closed).

When it is desired to extract a disk, the booklet is opened and the portion 10 of the tray is pivoted upwards together with its disks, as represented by arrow F in FIG. 2A. the presence of the indentations 12 makes it easier to take hold of a disk.

The indentations 12 thus perform two functions:

their (concave) top faces, constituting small cups, enable a finger to be inserted to enable the central portion 10 to be folded upwards; and

their (concave) bottom faces serve to bond the frame 100 to the cover 20 of the support.

It is thus easy to remove the disk C1, even without pivoting the moving central portion 10.

In order to take hold of the bottom disk C2, it is necessary to pivot this portion (FIGS. 5 to 7).

Each of the disks is accessible independently of the other.

The two elements 10 and 100 of the tray are preferably molded simultaneously by injection molding into a cavity that possesses a rim shaped to constitute the gap 4 between these two elements. Nevertheless, the rim is interrupted to leave a few linking points (or bridges) for example two bridges referenced 40 in FIGS. 5 to 8.

These ridges are mechanically weak and are easily broken in shear.

Thus, on leaving the mold, the tray 1 constitutes a rigid assembly, with the portion 10 lying in the same general plane as the frame 100, thus making it easier to handle, in particular to be stacked and transported, and also possibly to be bonded (by the printer) onto the support sheet 2.

To prepare it for use, the portion 10 is forced so as to break the bridges 40, thus allowing it to pivot freely.

The variant of the trade shown in FIGS. 9 to 12 is adapted to receive three disks, two of them, C1 and C2, being carried by the pivoting central portion 10, as in the above-described embodiment, while the third disk, C3, is inserted and retained in the central opening.

In addition, the portion 10 is provided with a pair of grip lugs 6 that face two setbacks 12 (on the side opposite from the hinge 3).

The double hub 11 is extended downwards by a portion 110 of smaller diameter, suitable for passing through the central opening of the disk C3.

At its base, the edge of the opening in the frame 100 presents retaining and support means 7 for the bottom disk C3.

In the example shown, four such means 7 are provided that are regularly distributed, two beside the hinge 3, and two others on the opposite side.

Each of them has a pair of abutment stops 71 surrounding an elastically-deformable retaining tab 70. It would naturally be possible to use the opposite configuration, i.e. a central abutment stop disposed between two retaining tabs.

When the disk C3 is pressed “home” in the opening of the frame 100, its edge goes past the tab 70 (the top of the tab being chamfered), and is thus held captive under the tab.

It rests via its margin zone on the abutments 71, preventing its inside face from coming directly into contact with the bottom cover 20 on which the tray is bonded (see FIG. 12).

In order to remove the disk C3, it is necessary to begin by pivoting the central portion 10 upwards, which is made easier by the presence of the lugs 6 facing the setbacks corresponding to the projections 12.

The tab 70 covers only very little of the edge of the disk C3, such that light flexing thereof, and/or elastic deformation of the tab 70, suffices to enable the disk to be extracted upwards once it has been grasped.

Naturally, a storage tray for storing only two disks, such as the tray forming part of the first embodiment, could also be provided with a pivoting central portion provided with lugs making it easier to grasp.

The breakable bridges, that initially connect the central portion to the frame, are advantageously made level with that these lugs, the lugs being shaped appropriately for this purpose.

1. A plastics material tray for storing at least one pair of compact disks, the tray being substantially square or rectangular in shape, and being made up of a central portion provided with a hub suitable for retaining a disk on an “outside” one of its faces, and of an outer portion, referred to as a “frame”, suitable for being adhesively bonded onto a support via its opposite, “inside” face, wherein firstly an opening slightly larger than the central portion is provided in the frame, and secondly said central portion is:
essentially detached from said frame, being secured thereto in part only, via a hinged connection;
adapted to be inscribed in said opening; and
provided with a double hub t enabling a pair of disks to be retained, one on its outside face and the other on its inside face, thus providing free access to each of the two disks in order to put the disk into place on the central portion or to remove it therefrom, without any need to remove the other disk, access to the disk held against the inside face requiring said central portion to be pivoted away from the general plane containing the frame.

2. A storage tray according to claim 1, wherein said central portion is of discoid shape, of diameter corresponding substantially to that of the disks, and that said slightly larger opening formed in said frame is a concentric circular opening, said hinged connection comprising a fastener tab secured to said central portion and a hinged to the frame in the central region of one of the sides of the tray.

3. A storage tray according to claim 1, wherein said central portion is initially rigidly connected to the frame by means of breakable bridges (40) that are suitable for being broken easily on first use.

4. A storage tray according to claim 1, wherein the central portion and the frame form two distinct parts and that said hinged link between the central portion and the frame is made by means of a label of flexible film adhering to said two parts, e.g. by overmolding.

5. A storage tray according to claim 1, wherein the central portion and the frame form a single part, and are made of a flexible plastics material that, in their link zone, presents a line of reduced thickness forming a hinge.

6. A storage tray according to claim 1, wherein the central portion and the frame form two distinct parts, and wherein said hinged link between the central portion and the frame is made by mechanical members such as studs forming stub hinge-pins.

7. A storage tray according to claim 1, adhesively bonded on a base sheet (2) of card or similar material.

8. A storage tray according to claim 7, wherein said base sheet on which the storage tray is bonded consists of a booklet, the tray being fastened on the inside face of the bottom cover of the booklet, while its top cover can be folded down onto the tray in order to protect the disks.

9. A storage tray according to claim 8, wherein said hinged link between the central portion and the frame is situated in the vicinity of the edge face of the booklet that interconnects its bottom and top covers.

10. A storage tray according to claim 1, wherein the edge of the opening formed in the outside portion is provided at its base with means for retaining and supporting a third disk, such that the third disk is interposed between the disk carried by the inside face of the central portion—when positioned in the general plane containing the frame—and the support onto which the frame is bonded.

11. A storage tray of plastics material for at least one pair of compact disks, which tray is designed to be fastened to a support by adhesive bonding, e.g. onto a base sheet of card or similar material, the tray being substantially square or rectangular in shape and being made up both of a central portion of circular outline, of diameter that corresponds substantially to the diameter of the disks, being provided in its center with a hub suitable for retaining a disk on an “outside” one of its faces, and of an outside portion—referred to as a “frame”—suitable for being adhesively bonded onto the said support via its opposite, “inside” face, by means of indentation in the form of projections located in the four corners of a notional square within which the circular outline of the central portion is inscribed, wherein, firstly said central portion is essentially detached from said frame, being secured in part thereto via a hinged link, and secondly it is provided with a double hub enabling a pair of disks to be retained, each on one of its faces, said central portion of generally circular outline being inscribed in a slightly larger concentric circular opening formed in said frame, while the hinged link comprises a fastener tab secured to said central portion, passing between two adjacent indentations, and being hinged to the frame in the central region of one of the sides of the tray.

12. A storage tray according to claim 11, wherein the storage tray is fastened on a base sheet constituted by a booklet, comprising a bottom cover onto which said tray is adhesively bonded, and a top cover suitable for being a folded down onto the tray in order to protect the disks, the two covers being connected to each other via pivot lines connecting to an intermediate portion constituting an edge face, of width corresponding substantially to the thickness of said tray, said hinged link between the central portion and the frame being situated in the vicinity of said edge face.

13. A storage case for at least one pair of compact disks, the case including a support on which at least one tray according to claim 1 is fastened.
